(19) United States
(12) Patent Application Publication
(10) Pub. No.: US 2026/0296816 A1
(43) Pub. Date: Oct. 1, 2026

(54) ELECTRODE TRANSFER DEVICE

(71) Applicant: SK ON CO., LTD., Seoul (KR)

(72) Inventors: Soo Yeon PARK, Daejeon (KR); Ji Won YANG, Daejeon (KR); Yun Jae KIM, Daejeon (KR)

(21) Appl. No.: 19/475,753

(22) PCT Filed: Sep. 23, 2024
(86) PCT No.: PCT/KR2024/014272

§ 371 Date: Oct. 16, 2025

(30) Foreign Application Priority Data
Sep. 27, 2023 (KR) 10-2023-0130192
Oct. 31, 2023 (KR) 10-2023-0147672

(51) Int. Cl. B65H 3/08; H01M 10/04

(52) U.S. Cl. CPC B65H 3/0808; H01M 10/0404

(57) ABSTRACT

The electrode transfer device of the present disclosure comprises: a first adsorption part for adsorbing a first area of one electrode among a plurality of electrodes; a second adsorption part for adsorbing a second area of the electrode; and a driving part for moving the electrode while the electrode is adsorbed. The lower surface of the second adsorption part adsorbing the second area is inclined at a set angle from the lower surface of the first adsorption part adsorbing the first area.

### TECHNICAL FIELD

The present disclosure relates to a secondary battery, and more specifically, to an electrode transfer device for a secondary battery.

### BACKGROUND ART

Secondary batteries are capable of repeatedly performing discharging, which converts chemical energy into electrical energy, and charging, which is the reverse process. Examples of secondary batteries may include nickel-cadmium (Ni—Cd) batteries, nickel-hydrogen (Ni—MH) batteries, lithium metal batteries, lithium ion batteries, lithium ion polymer batteries, and the like.

Secondary batteries can be manufactured by repeatedly stacking electrodes and separators. During the manufacturing process of secondary batteries, an electrode transfer device can adsorb electrodes and move the electrodes to specific locations (such as stacking locations). In this case, defects may occur, such as two or more sheets of electrodes being adsorbed or adsorption marks being left on the electrodes, and measures to solve such problems are required.

### DISCLOSURE

### Technical Problem

The present disclosure provides an electrode transfer device transferring an electrode of a secondary battery.

### Technical Solution

An electrode transfer device according to an embodiment of the present disclosure includes a first adsorption part for adsorbing a first area of one electrode among a plurality of electrodes, a second adsorption part for adsorbing a second area of the electrode, and a driving part for moving the electrode while the electrode is adsorbed. A lower surface of the second adsorption part adsorbing the second area is inclined at a set angle from a lower surface of the first adsorption part adsorbing the first area.

In an embodiment, the set angle may be greater than 0 degrees and less than 10 degrees.

In an embodiment, a plate to which the first adsorption part and the second adsorption part are fixed may be further included.

In an embodiment, the second adsorption part may be fixed to the plate in a state inclined with respect to the plate so that the lower surface of the second adsorption part is inclined at the set angle.

In an embodiment, the lower surface of the second adsorption part may be formed in a shape inclined at the set angle and the second adsorption part is fixed to the plate in a state parallel to the plate.

In an embodiment, a distance between the second area and a center of the electrode may be greater than a distance between the first area and the center of the electrode.

In an embodiment, an area of the second area may be larger than an area of the first area.

In an embodiment, a shape of the first area may be a circle or an ellipse.

In an embodiment, a shape of the second area may be a quadrilateral.

In an embodiment, the second adsorption part may adsorb the second area after the first adsorption part adsorbs the first area.

In an embodiment, the second adsorption part may simultaneously adsorb the second area while the first adsorption part adsorbs the first area.

In an embodiment, one suction hole may be formed in the first adsorption part.

In an embodiment, a plurality of suction holes may be formed in the second adsorption part.

In an embodiment, a diameter of each of the suction holes of the second adsorption part may be smaller than a diameter of the suction hole of the first adsorption part.

### Advantageous Effects

The present disclosure may provide an electrode transfer device for transferring an electrode of a secondary battery.

The electrode transfer device of the present disclosure may transfer an electrode at high speed.

The electrode transfer device of the present disclosure may prevent two or more sheets of electrodes from being adsorbed.

The electrode transfer device of the present disclosure may minimize or prevent adsorption marks on an electrode.

### DESCRIPTION OF DRAWINGS

FIGS. 1A and 1B are diagrams illustrating an electrode transfer device according to an embodiment.

FIG. 2 is a diagram illustrating an electrode according to an embodiment.

FIG. 3 is a diagram illustrating an electrode stack according to an embodiment.

FIG. 4 is a diagram illustrating adsorption parts according to an embodiment.

FIGS. 5 to 11 are diagrams illustrating an operation of an electrode transfer device according to an embodiment.

### MODES OF THE INVENTION

Specific structural or functional descriptions disclosed herein are merely illustrative for the purpose of describing embodiments according to the technical spirit of the present invention. Embodiments according to the technical spirit of the present invention may be implemented in various forms in addition to the embodiments disclosed herein, and should not be construed as being limited to the specific embodiments set forth herein.

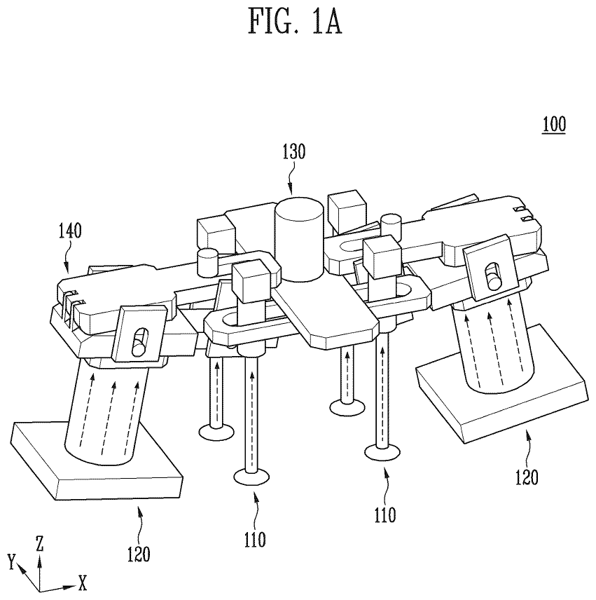

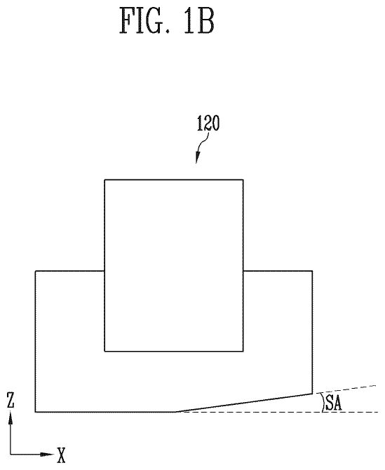

FIGS. 1A and 1B are diagrams illustrating an electrode transfer device according to an embodiment.

Referring to FIGS. 1A and 1B, an electrode transfer device 100 may include at least one first adsorption part 110, at least one second adsorption part 120, and a driving part 130.

Each of the first adsorption part 110 and the second adsorption part 120 may adsorb an electrode of a secondary battery. The secondary battery is a battery cell of various types such as a pouch type, a cylindrical type, and a prismatic type, and the electrode may be a positive electrode or a negative electrode.

A suction hole may be formed in each of the first adsorption part 110 and the second adsorption part 120. The electrode may be adsorbed or the adsorption may be stopped depending on the pressure in the suction hole. For example, when the pressure in the suction hole is lower than a reference pressure, the electrode may be adsorbed. For another example, the adsorption of the electrode may be stopped when the pressure in the suction hole is higher than or equal to the reference pressure. Here, the reference pressure may be one atmosphere, but is not limited thereto and may be set to various values. In an embodiment, suction holes having different shapes may be formed in the first adsorption part 110 and the second adsorption part 120.

In an embodiment, each of the first adsorption part 110 and the second adsorption part 120 may individually adjust the pressure. For example, the pressure may be adjusted so that only one of the first adsorption part 110 and the second adsorption part 120 adsorbs the electrode. For another example, each of the first adsorption part 110 and the second adsorption part 120 may adjust the pressure so that the first adsorption part 110 and the second adsorption part 120 simultaneously or sequentially adsorb the electrodes. In an embodiment, the electrode transfer device 100 may further include an ejector for adjusting the pressure of each of the first adsorption part 110 and the second adsorption part 120. The ejector may generate a vacuum (or low pressure) using compressed air when adsorbing the electrode, or may use compressed air to stop the adsorption of the electrode (i.e., release of the electrode).

The driving part 130 may move the first adsorption part 110 and the second adsorption part 120 in a vertical direction or a horizontal direction. For example, the vertical direction may be a Z-axis direction, and the horizontal direction may be an X-axis direction or a Y-axis direction. The X, Y and Z-axes may be perpendicular to each other. The driving part 130 may move the electrode while the electrode is being adsorbed. That is, while the first adsorption part 110 and the second adsorption part 120 adsorb the electrodes, the driving part 130 may move the first adsorption part 110 and the second adsorption part 120 in the vertical direction or the horizontal direction. For example, the driving part 130 may be implemented as a SCARA robot, a Cartesian robot, or the like. The Cartesian robot (or single-axis robot) may be a robot capable of linear movement with respect to one of a horizontal (left-right) direction or a vertical (up-down) direction, or rotational movement with respect to an axial direction. The SCARA robot (or multi-axis robot) may be a robot capable of moving in a horizontal (left-right) direction and a vertical (up-down) direction. The driving part 130 may include an AC motor or a DC motor. In an embodiment, the driving part 130 may further include at least one of a ball screw or a cylinder. The above-described embodiment is merely an embodiment, and the driving part 130 may be implemented in various forms.

In an embodiment, the electrode transfer device 100 may further include a plate 140. The plate 140 may fix the first adsorption part 110 and the second adsorption part 120.

In an embodiment, the first adsorption part 110 may include a suction cup facing the electrode and a first sleeve connected to the suction cup. The first sleeve may be fixed to the plate 140. The suction cup may be composed of a non-metallic material such as rubber, silicone, plastic, or the like. In an embodiment, the second adsorption part 120 may include a suction pad facing the electrode and a second sleeve connected to the suction pad. The second sleeve may be fixed to the plate 140. The suction pad may be composed of a non-metallic material such as rubber, silicone, plastic, or the like. The suction pad may be a contact or non-contact pad.

In an embodiment, a lower surface of the second adsorption part 120 may be inclined with respect to a lower surface of the first adsorption part 110.

In an embodiment, the lower surface of the second adsorption part 120 may be formed in a shape parallel to the lower surface of the first adsorption part 110. The second adsorption part 120 may be fixed to the plate 140 in a state inclined with respect to the plate 140. In this case, as shown in FIG. 1A, the lower surface of the second adsorption part 120 may be inclined at a set angle with respect to the lower surface of the first adsorption part 110.

In another embodiment, the lower surface of the second adsorption part 120 may be formed in a shape inclined at a set angle SA with respect to the lower surface of the first adsorption part 110. The second adsorption part 120 may be fixed to the plate 140 in a state parallel to the plate 140. In this case, as shown in FIG. 1B, the lower surface of the second adsorption part 120 may be inclined at the set angle SA with respect to the lower surface of the first adsorption part 110. That is, the second adsorption part 120 may be formed in a tapered shape.

The electrode transfer device 100 according to an embodiment of the present disclosure may prevent t two or more sheets of electrodes from being adsorbed. The electrode transfer device 100 may prevent the electrode from being crumpled during an electrode adsorption process.

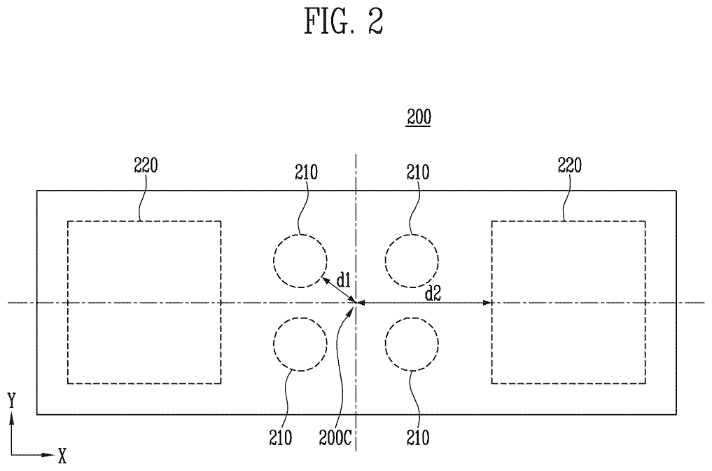

FIG. 2 is a diagram illustrating an electrode according to an embodiment. FIG. 2 shows an upper surface of the electrode.

Referring to FIGS. 1A and 2, an electrode 200 may be a positive electrode or a negative electrode included in the secondary battery. An upper surface of the electrode 200 may include a first area 210 and a second area 220. In an embodiment, the electrode 200 may have a thin film or foil structure having a thickness of a certain level or less. In an embodiment, the electrode 200 may further include an electrode tab (not shown).

In an embodiment, the lower surface of the first adsorption part 110 of the electrode transfer device 100 may face the first area 210 of the upper surface of the electrode 200, and the lower surface of the second adsorption part 120 may face the second area 220 of the upper surface the electrode 200. For example, the first area 210 may be located in a central area of the upper surface of the electrode 200, and the second area 220 may be located in an edge area of the upper surface of the electrode 200. In this case, the second adsorption parts 120 may be arranged with the first adsorption parts 110 interposed therebetween.

In an embodiment, the number of the first adsorption parts 110 and the number of the first area 210 may be the same, and the number of the second adsorption parts 120 and the number of the second areas 220 may be the same. For example, the number of the first adsorption parts 110 and the number of the first areas 210 may be four, and the number of the second adsorption parts 120 and the number of the second areas 220 may be two. However, this is merely an embodiment, and the number and arrangement of the first adsorption parts 110 and the second adsorption parts 120 may be variously modified according to the size or shape of the electrode.

In an embodiment, a distance d2 between the second area 220 and a center 200C of the electrode 200 may be greater than a distance d1 between the first area 210 and the center 200c of the electrode 200. That is, the second area 220 may be located at a greater distance from the center 200C than the first area 210.

In an embodiment, an area of the second area 220 may be larger than an area of the first area 210. That is, the area where the second adsorption part 120 faces (or contacts) the electrode 200 may be larger than the area where the first adsorption part 110 faces (or contact) the electrode 200.

In an embodiment, the shape of the first area 210 may be a circle or an ellipse. That is, the shape of the lower surface of the first adsorption part 110 may be a circle or an ellipse.

In an embodiment, the shape of the second area 220 may be a quadrilateral. That is, the shape of the lower surface of the second adsorption part 120 may be a quadrilateral. For example, the quadrilateral may be a square, a rectangle, a rhombus, a trapezoid, or the like. However, this is merely an embodiment, and the shape of the second area 220 may be modified and implemented in a polygon including a straight line or a curve.

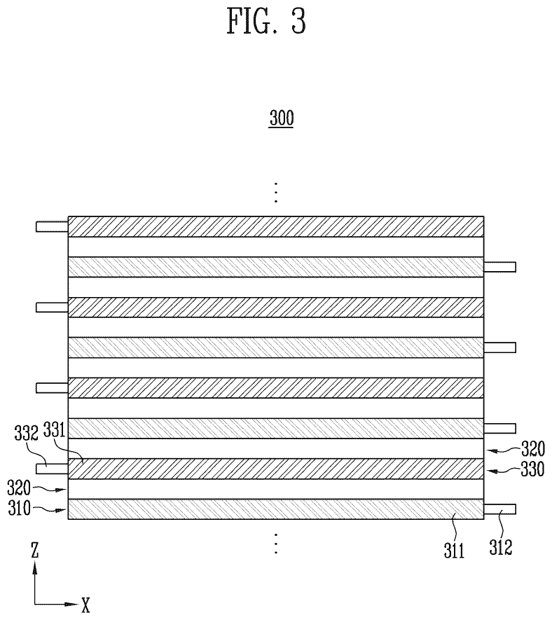

FIG. 3 is a diagram illustrating an electrode stack according to an embodiment.

Referring to FIG. 3, an electrode stack 300 may include a negative electrode 310, a separator 320, and a positive electrode 330. The electrode stack 300 may be a stack in which the negative electrode 310, the separator 320, and the positive electrode 330 are repeatedly stacked so that the separator 320 is positioned between the negative electrode 310 and the positive electrode 330. Here, the negative electrode 310 and the positive electrode 330 may each correspond to the electrode 200 described above.

The negative electrode 310 may include a negative electrode plate 311 and a negative electrode tab 312 projecting from one end of the negative electrode plate 311, and the positive electrode 330 may include a positive electrode plate 331 and a positive electrode tab 332 projecting from one end of the positive electrode plate 331. In an embodiment, the negative electrode 310, the separator 320, and the positive electrode 330 may be repeatedly stacked so that the negative electrode tab 312 and the positive electrode tab 332 are positioned in different directions. The electrode transfer device of the present disclosure may adsorb and move the negative electrode 310 or the positive electrode 330 to stack the negative electrode 310 or the positive electrode 330.

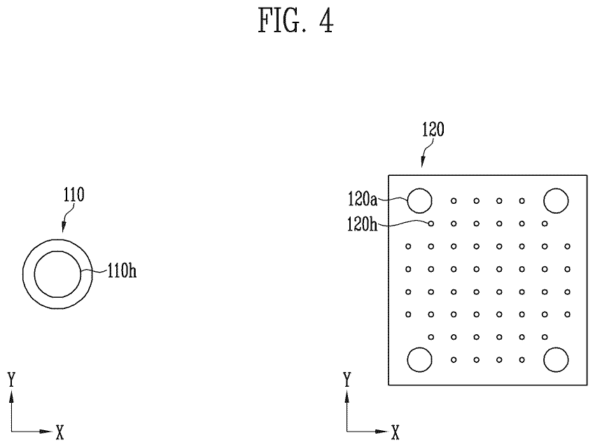

FIG. 4 is a diagram illustrating adsorption parts according to an embodiment. FIG. 4 shows the lower surfaces of the first and second adsorption parts.

Referring to FIGS. 1A and 4, the electrode transfer device 100 may include the first adsorption part 110 and the second adsorption part 120. The lower surfaces of the first adsorption part 110 and the second adsorption part 120 may face (or contact) a lower surface of the electrode to adsorb the electrode.

In an embodiment, one suction hole 110h may be formed in the first adsorption part 110. The pressure in the suction hole 110h may be adjusted by the first adsorption part 110 itself or by the ejector connected to the first adsorption part 110. In an embodiment, the first adsorption part 110 may measure the pressure formed in the first suction hole 110h.

In an embodiment, a plurality of suction holes 120h may be formed in the second adsorption part 120.

The plurality of suction holes 120h may be formed at positions which do not interfere with other mechanisms 120a in the second adsorption part 120. For example, the other mechanisms 120a may be a stack mandrel or the like.

In an embodiment, a diameter of the suction hole 120h of the second adsorption part 120 may be smaller than a diameter of the suction hole 110h of the first adsorption part 110. In an embodiment, an area of the suction hole 120h of the second adsorption part 120 may be smaller than an area of the suction hole 110h of the first adsorption part 110.

In an embodiment, the second adsorption part 120 may adsorb the electrode in a non-contact manner. For this purpose, the area of the second adsorption part 120 may be larger than a reference value. For example, the reference value may be n times the area of the first adsorption part 110, where n is an integer greater than or equal to 1. For example, even when the second adsorption part 120 having a large area is close to the electrode in a state of not being in contact with the electrode.

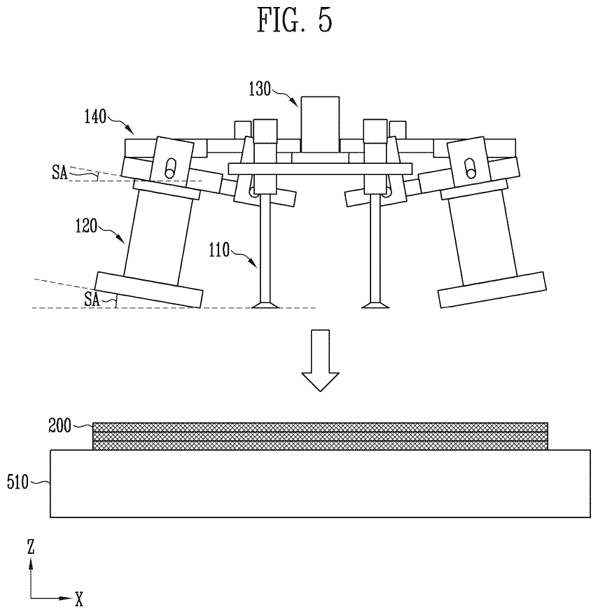

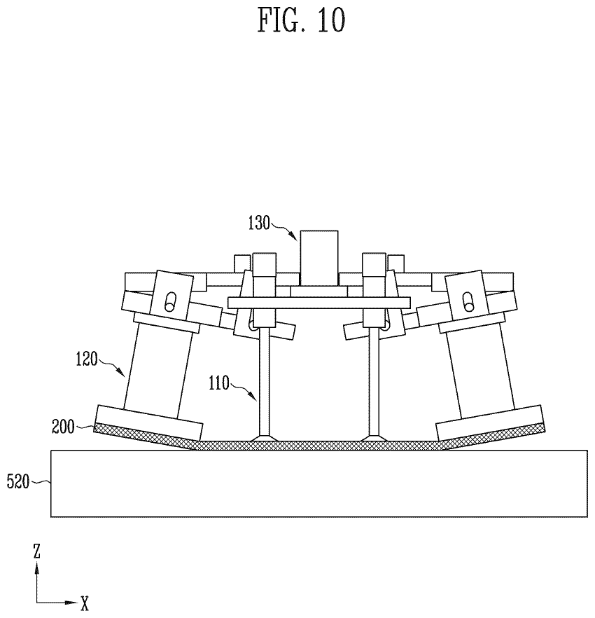

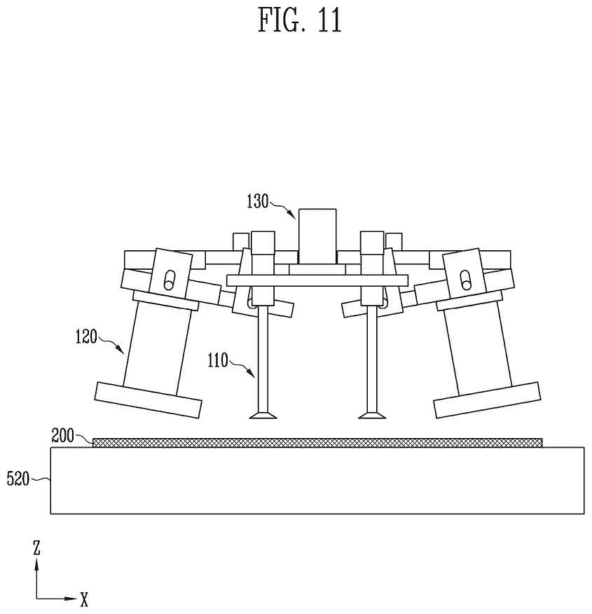

FIGS. 5 to 11 are diagrams illustrating an operation of an electrode transfer device according to an embodiment. FIGS. 5 to 11 illustrate the operation of the electrode transfer device according to an embodiment in chronological order.

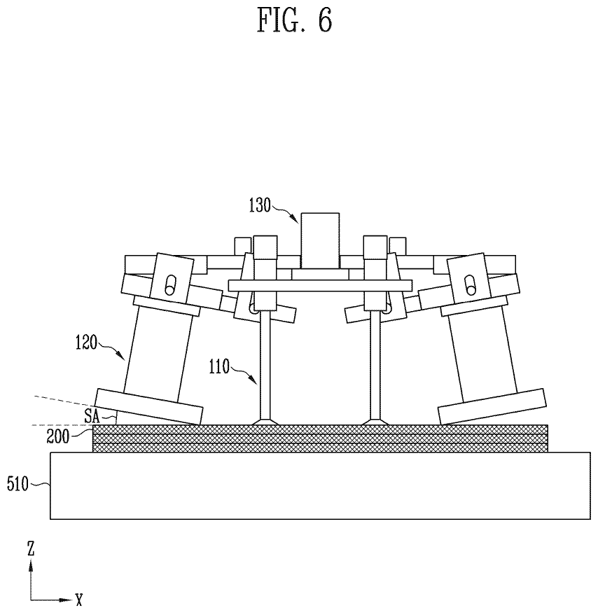

Referring to FIGS. 5 and 6, a plurality of electrodes (or one electrode) may be stacked in the vertical direction on a take-out plate 510. The vertical direction may be the Z-axis direction. The electrodes stacked on the take-out plate 510 may be adsorbed and transferred by the electrode transfer device 100. The take-out plate 510 may have a flat structure, but this is merely an embodiment, and may have a structure in which columns or walls surrounding side ends of the plurality of electrodes are present.

Referring to FIG. 5, the electrode transfer device 100 may be located over the plurality of electrodes. In an embodiment, the electrode transfer device 100 may be moved in the horizontal direction by the driving force of the driving part 130 to be positioned over the plurality of electrodes.

The lower surface of the second adsorption part 120 of the electrode transfer device 100 may be inclined at the set angle SA from the lower surface of the first adsorption part 110. In an embodiment, the lower surface of the first adsorption part 110 may be a lower surface of the suction cup. In an embodiment, the lower surface of the second adsorption part 120 may be a lower surface of the suction pad.

In an embodiment, the set angle SA may be greater than 0 degrees and less than 10 degrees. In this case, a distance between the lower surface of the second adsorption part 120 and the electrode 200 may increase in a direction from the lower surface of the second adsorption part 120 outwards. The outward direction may be a direction in which a distance from the first adsorption part 110 increases in the horizontal direction (e.g., the X-axis direction). Accordingly, it is possible to prevent other electrodes except for the electrode 200 located at the top of the plurality of electrodes from being adsorbed. If the lower surface of the second adsorption part 120 is not in an inclined state, an electrode located at a lower part of the plurality of electrodes may be adsorbed by the second adsorption part 120 when the plurality of electrodes are not aligned.

In an embodiment, the lower surface of the second adsorption part 120 may be formed in a shape parallel to the lower surface of the first adsorption part 110. The second adsorption part 120 may be fixed to the plate 140 while being inclined to the plate 140. In this case, as shown in FIG. 5, the lower surface of the second adsorption part 120 may be inclined at a set angle with respect to the lower surface of the first adsorption part 110. In another embodiment, the lower surface of the second adsorption part 120 may be formed in a shape inclined at a set angle with respect to the lower surface of the first adsorption part 110. The second adsorption part 120 may be fixed to the plate 140 in a state parallel to the plate 140. In this case, as shown in FIG. 1B, the lower surface of the second adsorption part 120 may be inclined at a set angle with respect to the lower surface of the first adsorption part 110.

Referring to FIGS. 5 and 6, the electrode transfer device 100 may move downward in the vertical direction to contact one electrode 200 among the plurality of electrodes. Here, one electrode 200 may be an electrode located at the top of the plurality of electrodes. For example, the vertical direction may be the Z-axis direction. In an embodiment, the driving force of the driving part 130 may move the electrode transfer device 100 in the vertical direction to contact the upper surface of one electrode 200. For example, the lower surface of the first adsorption part 110 may contact the first area of the upper surface of the electrode 200. The lower surface of the second adsorption part 120 may contact the second area of the upper surface of the electrode 200 or may be in a non-contact state.

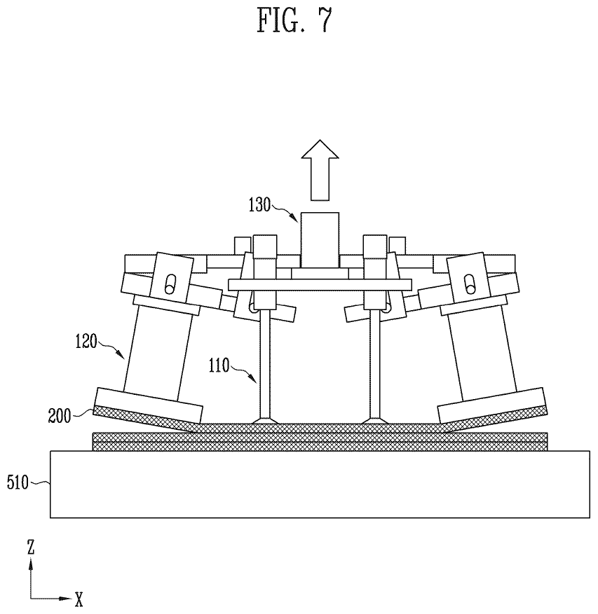

Referring to FIGS. 6 and 7, the first adsorption part 110 may adsorb the first area of the electrode 200. In an embodiment, the second adsorption part 120 may adsorb the second area of the electrode 200 after the first adsorption part 110 adsorbs the first area of the electrode 200. In another embodiment, the second adsorption part 120 may simultaneously adsorb the second area of the electrode 200 while the first adsorption part 110 adsorbs the first area of the electrode 200. In this case, only one electrode 200 located at the top of the plurality of electrodes arranged on the take-out plate 510 may be adsorbed. In an embodiment, a portion of the electrode 200 may be inclined according to the set angle SA at which the second adsorption part 120 is inclined.

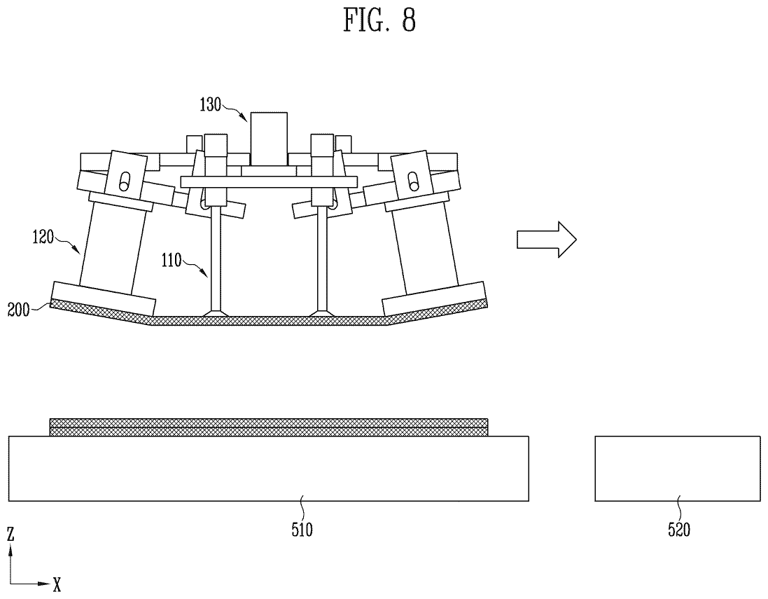

Referring to FIGS. 7 and 8, the driving part 130 may move the electrode 200 while the electrode 200 is adsorbed. For example, while the electrode 200 is adsorbed by the first adsorption part 110 and the second adsorption part 120, the driving part 130 may move the electrode transfer device 100 upward in the vertical direction and move the electrode transfer device 100 in the horizontal direction. In this case, the electrode transfer device 100 may be located over a placement plate 520. The placement plate 520 may be a destination to which the electrode 200 is moved.

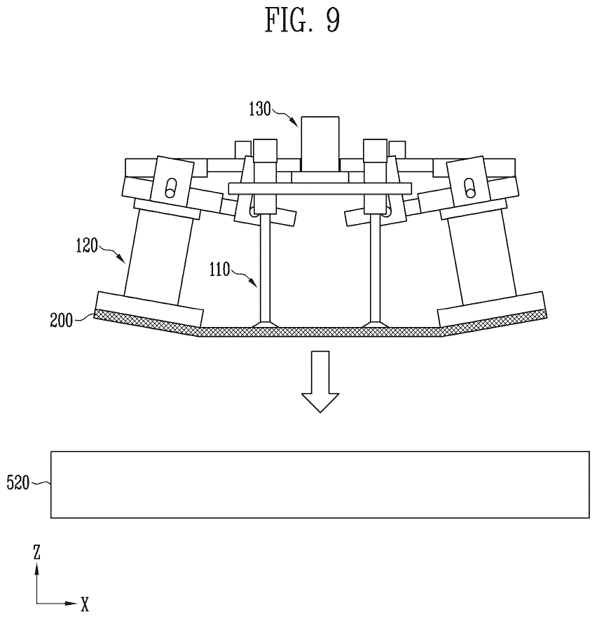

Referring to FIGS. 9 to 11, the electrode transfer device 100 may be moved downward in the vertical direction by the driving part 130. The electrode transfer device 100 may move downward to a set height over the placement plate 520, stop the adsorption of the electrode 200, and release the electrode 200 on an upper surface of the placement plate 520. In an embodiment, the second adsorption part 120 may first stop the adsorption of the electrode 200, and then the first adsorption part 110 may stop the adsorption of the electrode 200. In another embodiment, the second adsorption part 120 and the first adsorption part 110 may simultaneously stop the adsorption of the electrode 200.

As described above, the electrode transfer device 100 according to an embodiment of the present disclosure may transfer the electrode 200 at high speed. In addition, the electrode transfer device 100 may prevent two or more sheets of electrodes from being adsorbed by the second adsorption part 120 having a slope. In addition, the electrode transfer device 100 may use the second adsorption part 120 together with the first adsorption part 110, thereby minimizing or preventing adsorption marks on the electrode 200 compared to an electrode transfer device composed only of the first adsorption part 110.

1. An electrode transfer device, comprising:
a first adsorption part for adsorbing a first area of one electrode among a plurality of electrodes;
a second adsorption part for adsorbing a second area of the electrode; and
a driving part for moving the electrode while the electrode is adsorbed,
wherein a lower surface of the second adsorption part adsorbing the second area is inclined at a set angle from a lower surface of the first adsorption part adsorbing the first area.

2. The electrode transfer device of claim 1, wherein the set angle is greater than 0 degrees and less than 10 degrees.

3. The electrode transfer device of claim 1, further comprising a plate to which the first adsorption part and the second adsorption part are fixed.

4. The electrode transfer device of claim 3, wherein the second adsorption part is fixed to the plate in a state inclined with respect to the plate so that the lower surface of the second adsorption part is inclined at the set angle.

5. The electrode transfer device of claim 3, wherein the lower surface of the second adsorption part is formed in a shape inclined at the set angle and the second adsorption part is fixed to the plate in a state parallel to the plate.

6. The electrode transfer device of claim 1, wherein a distance between the second area and a center of the electrode is greater than a distance between the first area and the center of the electrode.

7. The electrode transfer device of claim 1, wherein an area of the second area is larger than an area of the first area.

8. The electrode transfer device of claim 1, wherein a shape of the first area is a circle or an ellipse.

9. The electrode transfer device of claim 8, wherein a shape of the second area is a quadrilateral.

10. The electrode transfer device of claim 1, wherein the second adsorption part adsorbs the second area after the first adsorption part adsorbs the first area.

11. The electrode transfer device of claim 1, wherein the second adsorption part simultaneously adsorbs the second area while the first adsorption part adsorbs the first area.

12. The electrode transfer device of claim 1, wherein one suction hole is formed in the first adsorption part.

13. The electrode transfer device of claim 12, wherein a plurality of suction holes are formed in the second adsorption part.

14. The electrode transfer device of claim 13, wherein a diameter of each of the suction holes of the second adsorption part is smaller than a diameter of the suction hole of the first adsorption part.
